(19) United States
(12) Patent Application Publication
(10) Pub. No.: US 2010/0017717 A1
(43) Pub. Date: Jan. 21, 2010

(54) VIDEO PROCESSING DEVICE AND CONTROL METHOD THEREFOR

(75) Inventor: Akira Nakanishi, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/502,987

(22) Filed: Jul. 14, 2009

(30) Foreign Application Priority Data
Jul. 16, 2008 (JP) 2008-184834

(51) Int. Cl. G06F 3/01

(52) U.S. Cl. 715/719

(57) ABSTRACT

According to one embodiment, a video processing device includes a video processor configured to process video information, and a controller configured to control the video processor. The controller includes a graphical user interface (GUI) module acquired in the form of a Web application, a Web browser which provides a user interface upon execution of the Web application for the GUI modules and a lower-level control module which incorporates an HTTP (Hypertext Transfer Protocol) server to perform a sequence control related the video processor and acquisition of status information in communication with the user interface on the Web browser.

### CROSS-REFERENCE TO RELATED APPLICATIONS

This application is based upon and claims the benefit of priority from Japanese Patent Application No. 2008-184834, filed Jul. 16, 2008, the entire contents of which are incorporated herein by reference.

### BACKGROUND

1. Field

One embodiment of the invention relates to a video processing device such as a hard disk recorder that records and reproduces video content or a television that displays video content, and to a control method for the video processing device.

2. Description of the Related Art

Generally, hard disk recorders and televisions contain a ROM storing a variety of software modules as firmware and the operations thereof are independently controlled by the software modules.

Recently, use of the Internet has been notable. Conventionally, there is a known technology (e.g., Jpn. Pat. Appln. KOKAI Publication No. 2005-107737) that controls various functions of an electronic device by registering software, such as an application program, received from such a network and executing the registered software. In such a technology, the electronic device updates the registered software in response to a request to rewrite the software.

However, the technology disclosed in Jpn. Pat. Appln. KOKAI Publication No. 2005107737 requires the rewriting of software even when a defect relating only to a user interface is corrected or one function is added. Additionally, when the device is of a type with a ROM storing firmware dedicated to the device, the manner of manual operations is usually changed upon change in the model of the device. Accordingly, a user who buys a new model of the same device has to learn the manner of manual operations for the model again.

### BRIEF DESCRIPTION OF THE SEVERAL VIEWS OF THE DRAWINGS

A general architecture that implements the various feature of the invention will now be described with reference to the drawings. The drawings and associated descriptions are provided to illustrate embodiments of the invention and not to limit the scope of the invention.

FIG. 1 is a diagram showing an example of the circuit configuration of a video recording/reproducing device serving as a video processing device according to an embodiment of the invention;

FIG. 2 is a diagram showing an example of the circuit configuration of a video display device serving as the video processing device according to the embodiment of the invention;

FIG. 3 is an exemplary view for explaining a combination of pictures obtained by a video compositor shown in FIGS. 1 and 2;

FIG. 4 is a schematic exemplary view of software implemented in the video recording/reproducing device shown in FIG. 1;

FIG. 5 is a view showing an example of data transmitted to an HTTP server when reproduction is actually requested in the video recording/reproducing device shown in FIG. 4;

FIG. 6 is a view showing an example of control for reproducing chapter 3 of title 2 from a point of five minutes in the video recording/reproducing device shown in FIG. 4;

FIG. 7 is a schematic exemplary view of software implemented in the video display device shown in FIG. 2;

FIG. 8 is an exemplary view explaining the concept of the conjoined operation of the video recording/reproducing device and video display device shown in FIGS. 1 and 2 respectively;

FIG. 9 is an example of the configuration in which a map image downloaded from a server on the Internet and a recorded video are synchronously combined for display in the video recording/reproducing device shown in FIG. 1;

FIG. 10 is an exemplary view of a picture obtained as a result of the combining operation in the configuration example shown in FIG. 9;

FIG. 11 is an exemplary view of a format for a closed caption inserted in extension-and-user-data used in the configuration example shown in FIG. 9;

FIG. 12 is a configuration example for acquiring subtitles, closed captions, electronic program guide (EPO), or other information related to a mV broadcast currently being received in the video display device shown in FIG. 2; and

FIG. 13 is an exemplary view showing subtitles obtained by the configuration example shown in FIG. 12.

### DETAILED DESCRIPTION

Various embodiments according to the invention will be described hereinafter with reference to the accompanying drawings.

According to one embodiment of the invention, there is provided a video processing device comprising: a video processor configured to process video Information; and a controller configured to control the video processor, the controller including: a graphical user interface (GUT) module acquired in the form of a Web application; a Web browser which provides a user interface upon execution of the Web application for the GUI module; and a lower-level control module which incorporates an HTTP (Hypertext Transfer Protocol) server to perform a sequence control related to the video processor and acquisition of status information in communication with the user interface on the Web browser.

According to one embodiment of the invention, there is provided a control method for a video processing device having a video processor configured to process video information and a controller configured to control the video processor, the method comprising: acquiring a graphical user interface (GUI) module in the form of a Web application; providing a user interface by a Web browser which executes the Web application for the GUI module; and performing a sequence control related to the video processor and acquisition of status information by a lower-level control module incorporating an HTTP (Hypertext Transfer Protocol) server which communicates with the user interface on the Web browser.

In the video processing device and control method for the video processing device, a graphical user interface (GUI) module is acquired as a Web application; a user interface is provided by a Web browser that executes the Web application for the GUI module; and a sequence control related to a video processor and acquisition of status information are performed by a lower-level control module incorporating an HTTP (Hypertext Transfer Protocol) server which communicates with the user interface on the Web browser. That is, since the GUT module is in the form of a Web application, it is unnecessary to rewrite firmware in order to correct a defect in the user interface or in order to provide an additional function. Further, when the device is of a type with a ROM storing dedicated firmware, a user does not have to learn the manner of manual operations again, upon change in the model off the device.

A video processing device according to an embodiment of the invention will be described below. The video processing device refers to a video recording/reproducing device such as a hard disk recorder or to a video display device such as a television. In this video processing device, a graphical user interface (GUI) and user interface (UI) are excluded from software that is incorporated as firmware in a device main body. The graphical user interface and user interface are implemented as Web applications described in HTML (Hypertext Markup Language) or JavaScript (registered trademark). Further, a lower-level control module is provided. This lower-level control module incorporates an HTTP (Hyper Text Transfer Protocol) server that has various control functions via an HTTP and Web browser. The three types of software, i.e., the Web application, Web browser, and lower-level control module, operate in conjunction. Adopting the Web-application-form GUI enables control logic to be described in a script such as Java Script, and enables collaboration with various Web services usable in Ajax (Asynchronous JavaScript and XML).

Incidentally, such a Web-application-form GUI is disposed in a ROM together with the firmware of the device main body. However, in an environment where an Internet connection is possible, the Web-application-form GUI may be disposed on the HTTP server on the Internet.

When the Web-application-form GUI is disposed on the HTTP server on the Internet, all devices of a corresponding model for the GUT perform the GUI Web application on the server on the Internet.

Accordingly, software update for correction of a defect in the GUI, provision of an additional function to the GUI, or improvement of operability for users can be performed outside the device main body.

Assigning separate URLs to various GUIs, such as a GUI that is easy to operate but has only a basic function or a GUI that is complex to operate but has a high-level function, enables a user to use a different GUI by simply changing the setting of the URL to which the user is referring. This eliminates the need to separately develop device models designed for those adept with a plethora of higher functions and device models designed for the novices. In addition, a control function to serve as a compatible Web service allows the use of the same GUI by setting the same URL even in different models, thus eliminating the need for a user buying a new model to learn the manner of manual operations for this model.

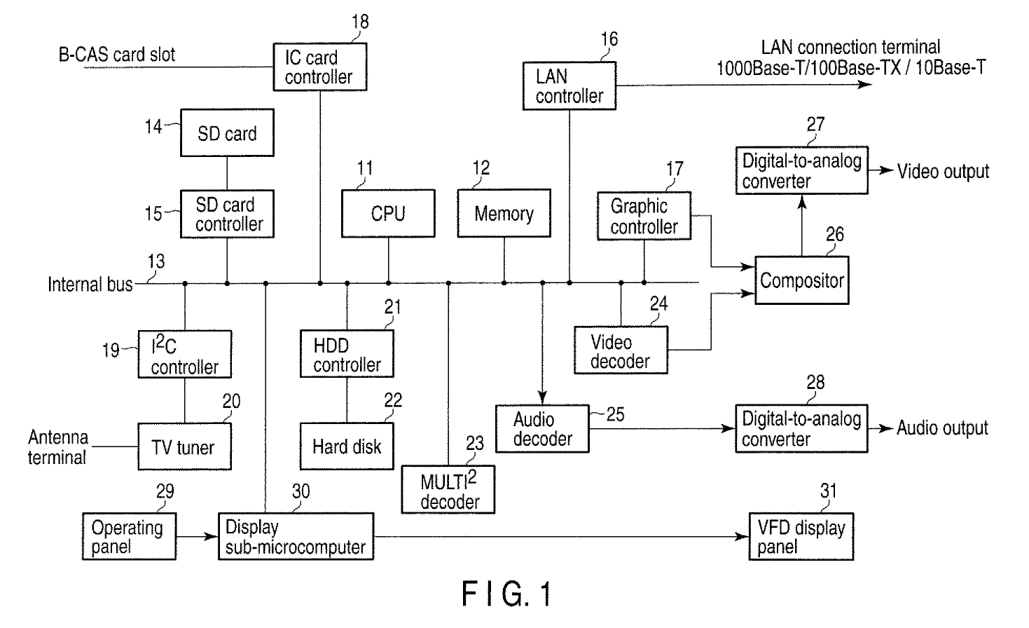

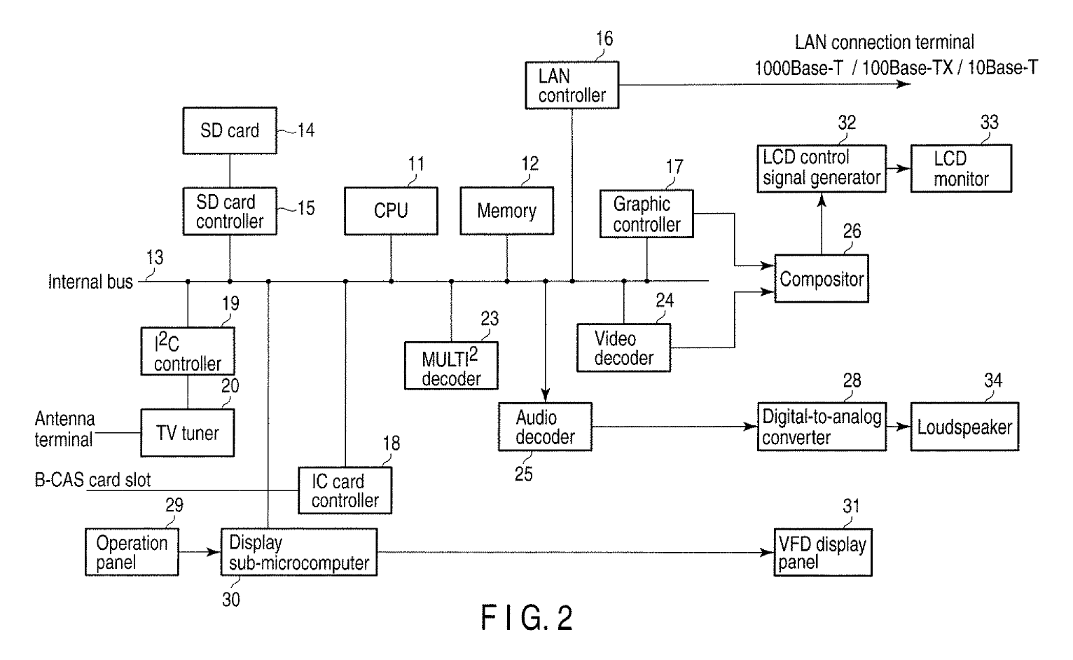

FIG. 1 shows an example of the circuit configuration of the video recording/reproducing device serving as the video processing device, and FIG. 2 shows an example of the circuit configuration of the video display device serving as the video processing device. The video recording/reproducing device in FIG. 1 includes: a CPU 11 for controlling the entire device; a memory 12 for storing software such as an OS (operation system) and applications performed by the CPU 11, and the data processed by the CPU 11; and an internal bus 13 for interconnecting the CPU 11 and memory 12. Additionally, the video recording/reproducing device includes an SD (Secure Digital) card 14, SD card controller 15, LAN controller 16, graphic controller 17, IC card controller 18, 12C controller 19, TV tuner 20, HDD controller 21, hard disk 22, MULTI² decoder 23, video decoder 24, audio decoder 25, compositor 26, digital-to-analog converter 27, digital-to-analog converter 28, operation panel 29, display sub-microcomputer 30, and vacuum fluorescent display (VFD) panel 31. Further, the CPU 11 is connected to the SD card controller 15, LAN controller 16, graphic controller 17, compositor 26, IC card controller 18, I²C controller 19, HDD controller 21, MULT² decoder 23, video decoder 24, audio controller 25, and display sub-microcomputer 30, through the internal bus 13.

The SD card controller 15 is connected to the SD card 14. The graphic controller 17 and video decoder 24 are connected to the compositor 26. The compositor 26 is connected to the digital-to-analog converter 27, from which video is output. The audio decoder 25 is connected to the digital-to-analog converter 28, from which audio is output. The LAN controller 16 is connected to a LAN connection terminal. The IC card controller 18 is connected to a B-CAS card slot. The I²C controller 19 is connected to a TV tuner 20, and the TV tuner 20 is connected to an antenna. The HDD controller 21 is connected to the hard disk 22. The operation panel 29 is connected to the display sub-microcomputer 30, and the display sub-microcomputer 30 is connected to the VFD panel 31.

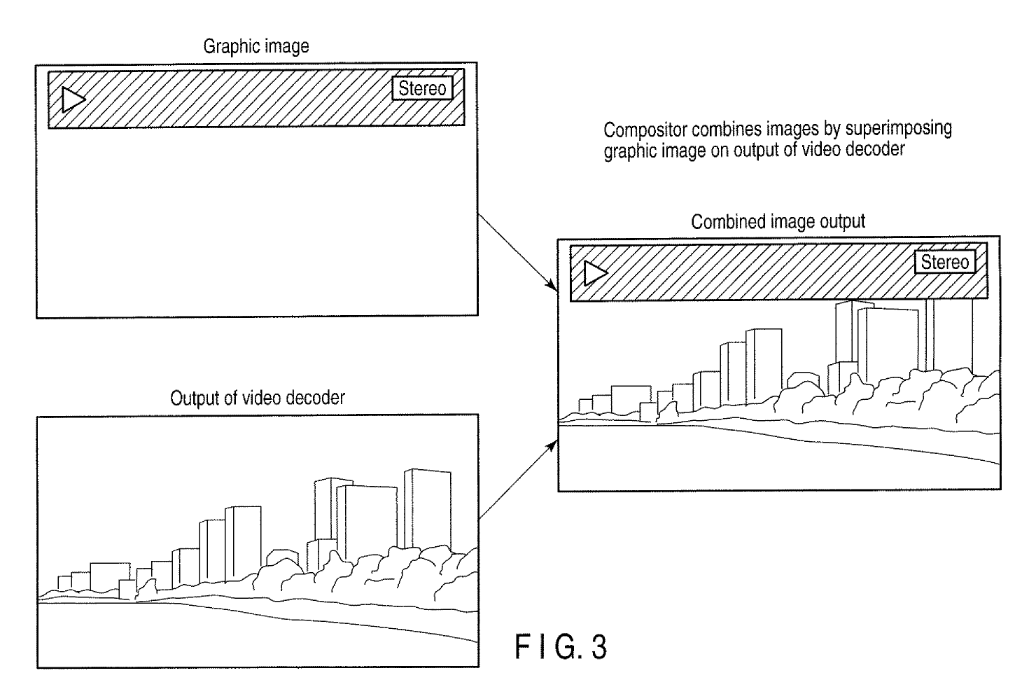

The TV tuner 20 receives electromagnetic waves corresponding to a specified channel and outputs digital data such as video and audio of a transmitted MPEG2 (Moving Picture Experts Group 2) TS (Transport Stream). Since the data output from the TV tuner 20 is in an encryption form encoded using an algorithm called “MULTI²,” this data is decoded by the MULTI² decoder 23 and then transmitted to the video decoder 24 or audio decoder 25. The IC card controller 18 is applied to reading of key information for MULTI² decoding from the digital broadcast B-CAS card. The hard disk 22 and hard disc (HDD) controller 21 are provided as a broadcast recording storage. During recording, the CPU 11 stores the results of MULTI² decoding in the hard disk 22. During reproduction, the CPU 11 reads a recorded stream of the MPEG2 TS from the hard disk 22, extracts video and audio signals by demultiplexing of the stream, and then supplies the video and audio signals to the video decoder 24 and audio decoder 25, respectively. When various information, such as a reproducing time, is drawn as an image in a display graphic memory by the graphic controller 17, the compositor 26 combines the output from the video decoder 24 and the image from the display graphic memory in real time by a hardware process, to output a video signal for display as shown in FIG. 3. The LAN controller 16 is an Ethernet registered trademark) controller for connecting to the Internet, etc. The SD card controller 15 reproduces a video recorded on the SD card 14 by a video camera or transfers it to the hard disk 22. Generally, if a power source is turned off, devices such as the CPU 11 and video decoder 24 are also turned off. However, in order to start a recording preset by a timer, the video processing device includes a microcomputer called “display sub-microcomputer” 30 which functions constantly regardless of the on/off status of the power source. The display sub-microcomputer 30 also monitors the buttons of the operation panel 29 in order to detect the depression of these buttons, receives an input from a remote controller, and controls time display, etc., shown on the VFD panel 31.

The video display device shown in FIG. 2 has the same configuration as the video recording/reproducing device shown in FIG. 1, except in the following respects: the HDD controller 21, hard disk 22, and digital-to-analog converter 27 shown in FIG. 1 are not included in the video display device. Instead, the compositor 26 is connected to an LCD (Liquid Crystal Display) control signal generator 32, which is connected to an LCD monitor 33. A digital-to-analog converter 28 is connected to a loudspeaker 34.

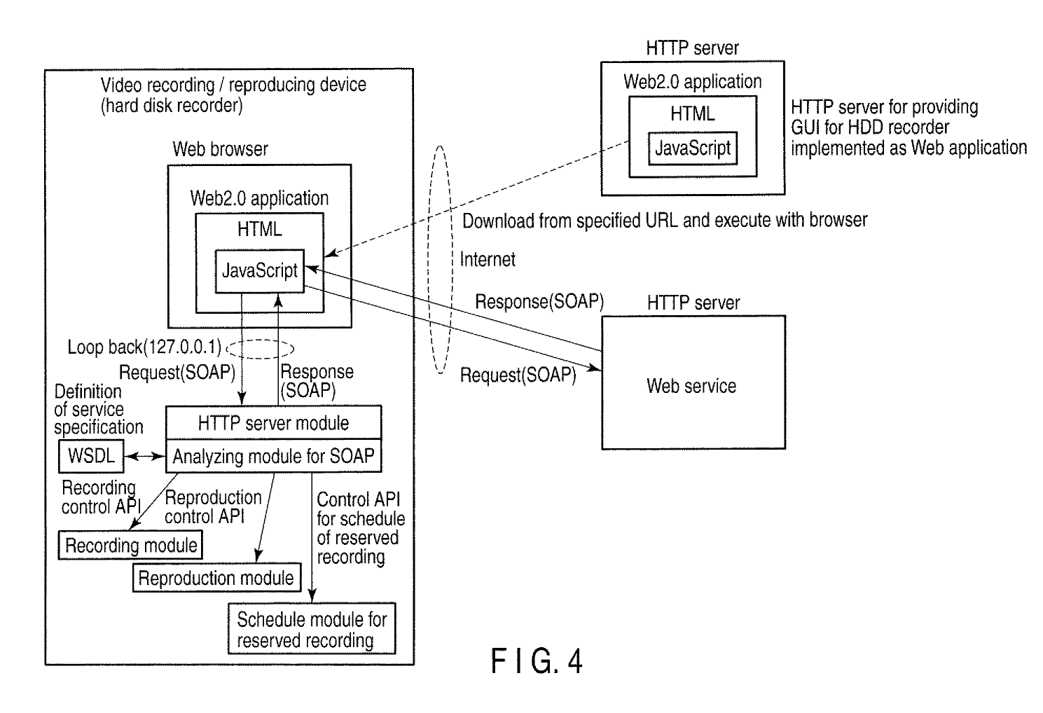

FIG. 4 is a schematic exemplary view of software incorporated in the video recording/reproducing device shown in FIG. 1. For use as application software for the CPU 11, the memory 12 stores: a graphical user interface (GUI) module acquired as a Web application; a Web browser which provides a user interface upon execution of the Web application for the GUI module; and a lower-level control module which incorporates an HTTP (hypertext Transfer Protocol) server to perform a sequence control related to the video processor and acquisition of status information in communication with the user interface on the Web browser. Here, the Web-application-form GUI is not disposed in the video recording/reproducing device but in the HTTP server on the Internet. In the video recording/reproducing device, the Web browser is provided to operate the GUI on the HTTP server. In addition, the Web-application-form GUI transmits/receives XML (Extensible Markup Language)-type data in JavaScript, thereby controlling the main body of the video recording/reproducing device. The specification of the control application program interface (API) of the video recording/reproducing device is such that the control application program is called on the HTTP protocol by transmitting or receiving a request or response defined by SOAP (Simple Object Access Protocol). On account of this, the video recording/reproducing device includes a module that analyzes the HTTP server and SOAP and calls up an actual API function. The Web application communicates with the internal HTTP server in the same manner as the HTTP server on the Internet by means of the internal loop back function of the operating system. WSDL (Web Services Description Language) defines a data format, i.e., the way in which request or response data for each API is set in the SOAP.

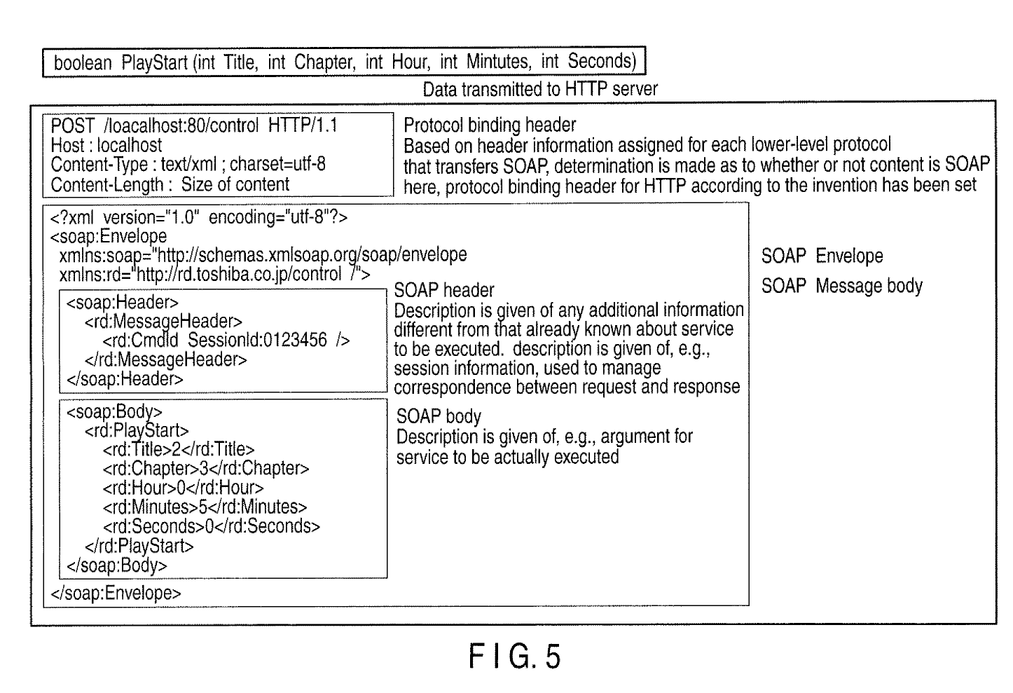

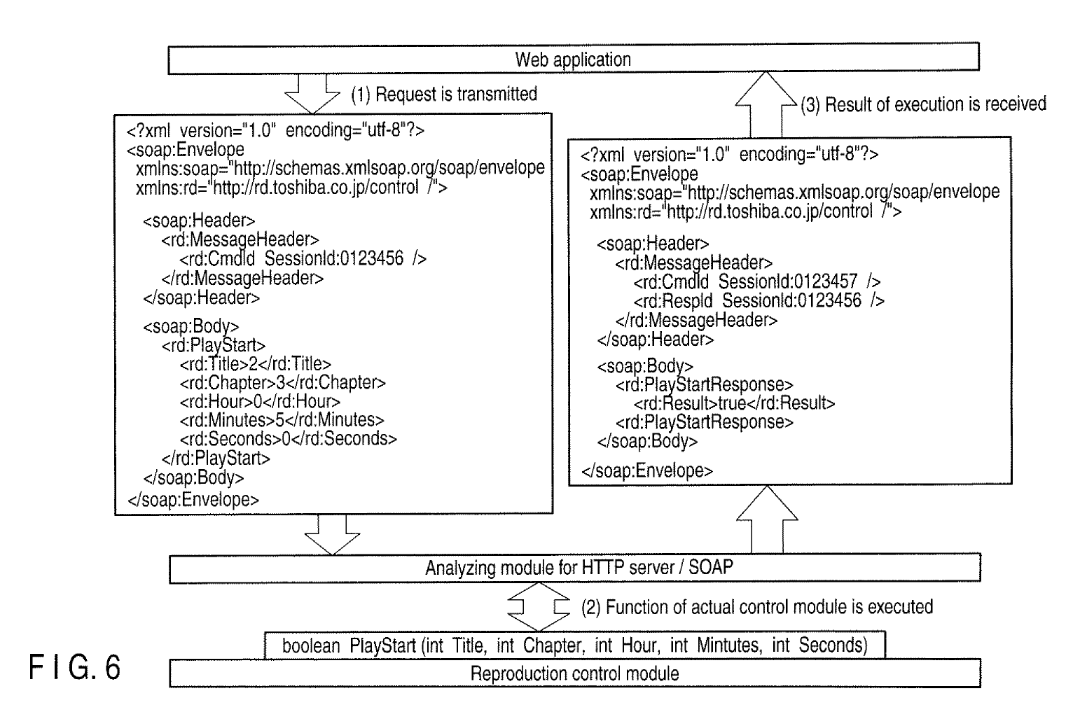

Incidentally, FIG. 5 shows an example of data transmitted to the HTTP server when reproduction is actually requested. FIG. 6 is an example of control for reproducing chapter 3 of title 2 from a point of five minutes.

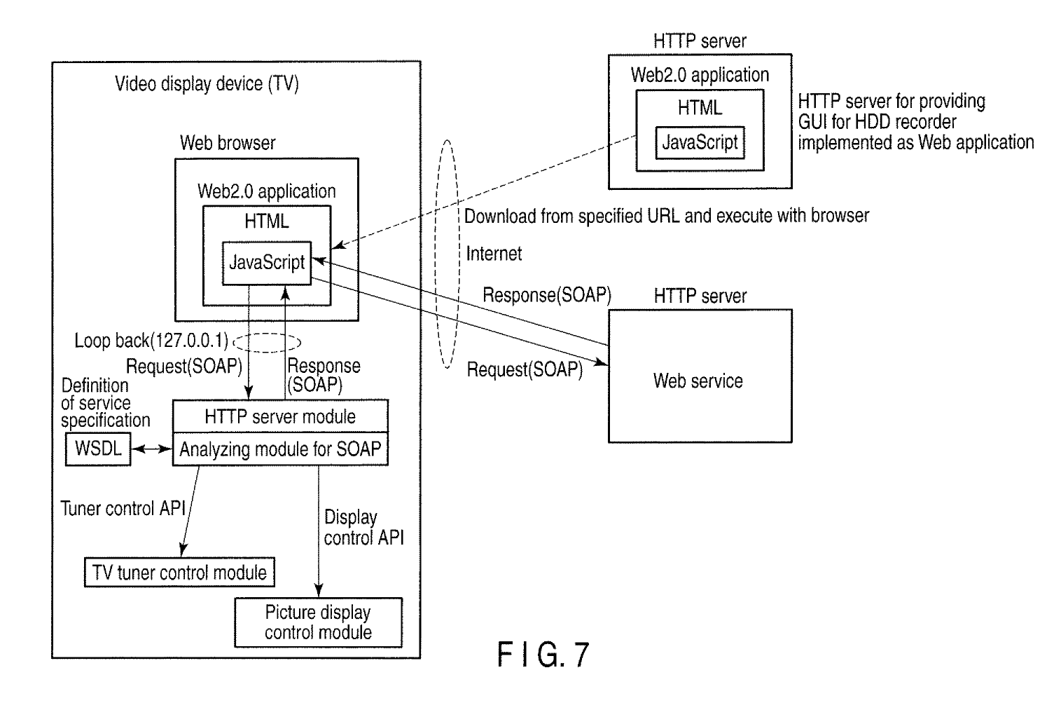

FIG. 7 shows a schematic view of software implemented in the video display device shown in FIG. 2. Basically, the video recording/reproducing device and GUI described above are disposed on the HTTP server. The main body is controlled by the SOAP on the HTTP. The control is exerted through JavaScript on the Web application. The main body of the software is also divided into: a main-body-side software providing a control API, such as a channel setting or input switching, in the form of a Web service; and a Web application on the HTTP server written in HTML or JavaScript.

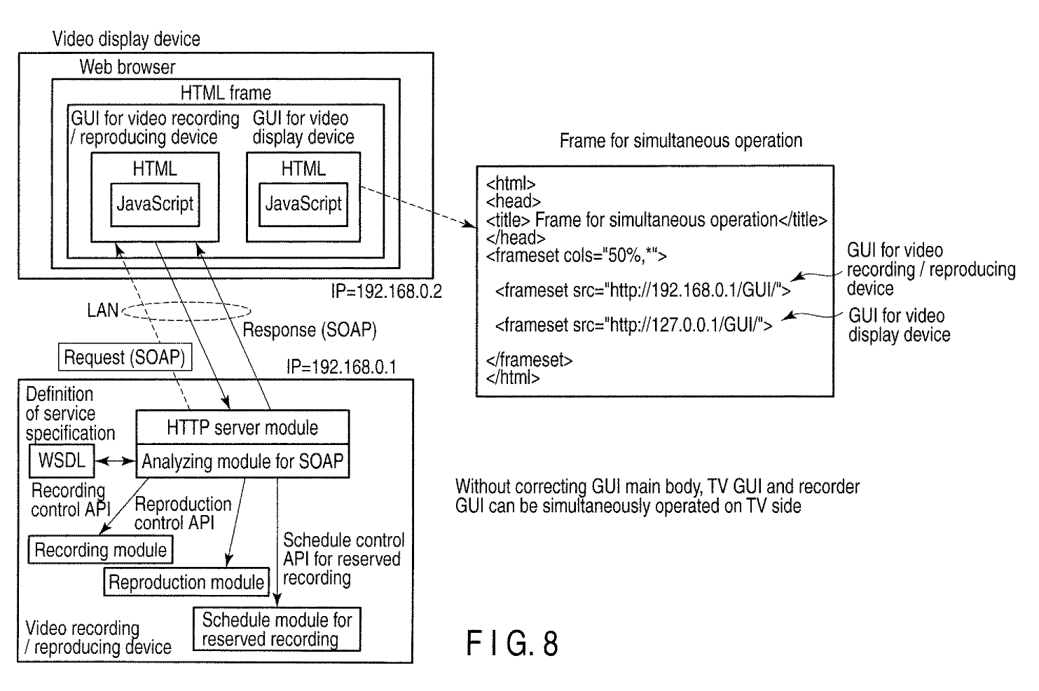

FIG. 8 is an exemplary view explaining the concept of the operation of the video display device and video recording/reproducing device in conjunction with each other. Conventionally, the video display device and video recording device each have GUI independently. Therefore, it has been difficult to operate them in conjunction while providing a user with operability exhibiting as if a single GUI is shared. However, designing GUIs in the form of Web applications makes it possible to combine all the GUIs to serve as Web services on the server. This enables a conjoined operation in which if a user instructs the video recording/reproducing device to start reproduction, the input of the video display device automatically switches to an input for connection to the video recording/reproducing device.

In the scheme shown in FIG. 8, a user operates the GUI of the video display device by using a Web browser on the video displaying/reproducing device side. Each of the video recording/reproducing device and video display device is connected to the LAN. Thus, by setting only the IP address of the video recording/reproducing device, the video display device can be operated and controlled in exactly the same manner as that when controlled via the Web browser on the recording/reproducing device side.

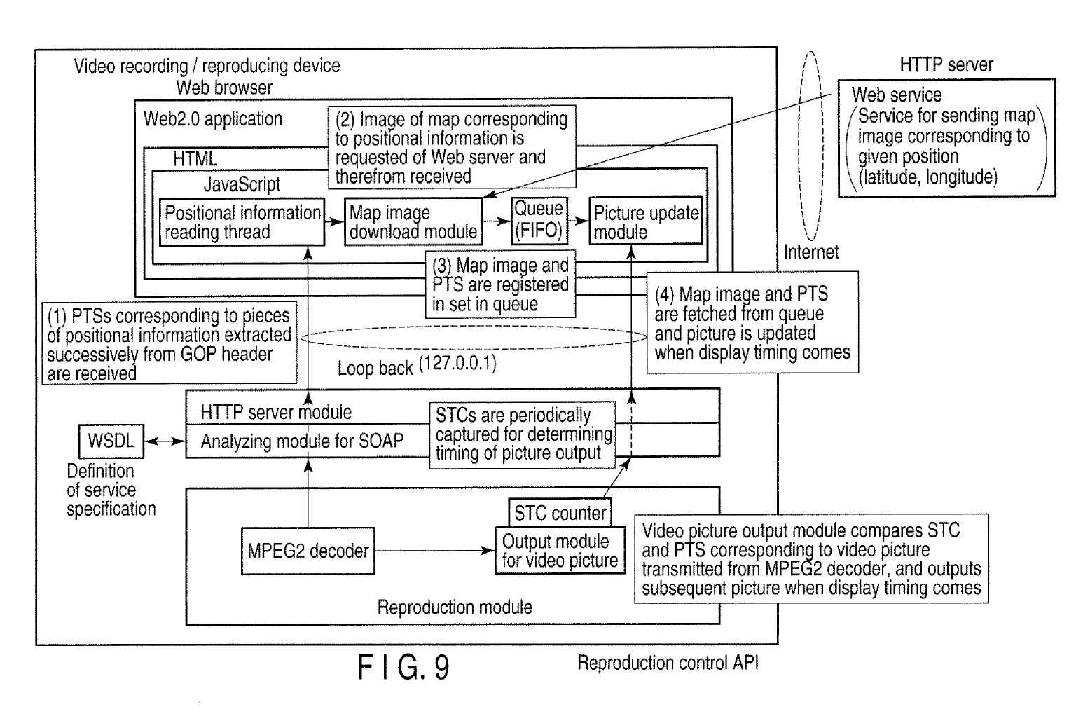

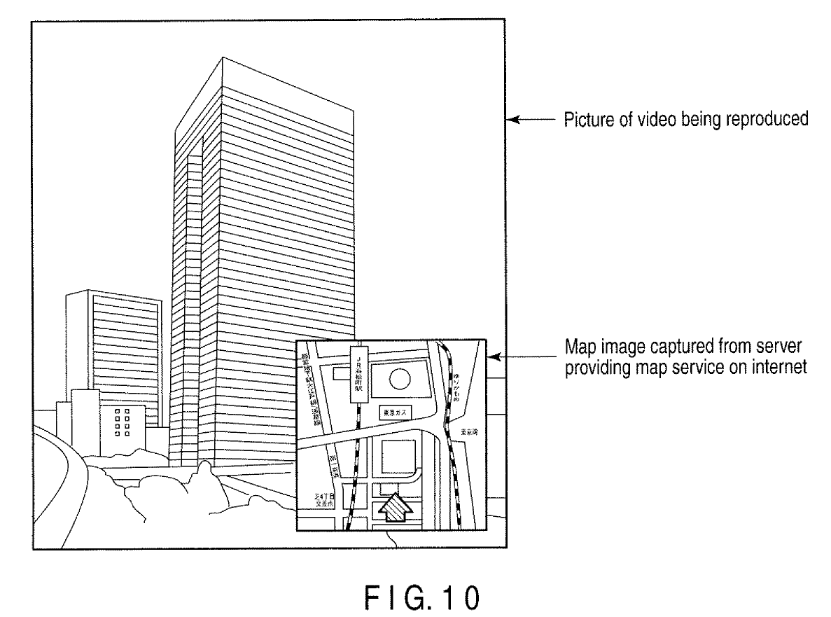

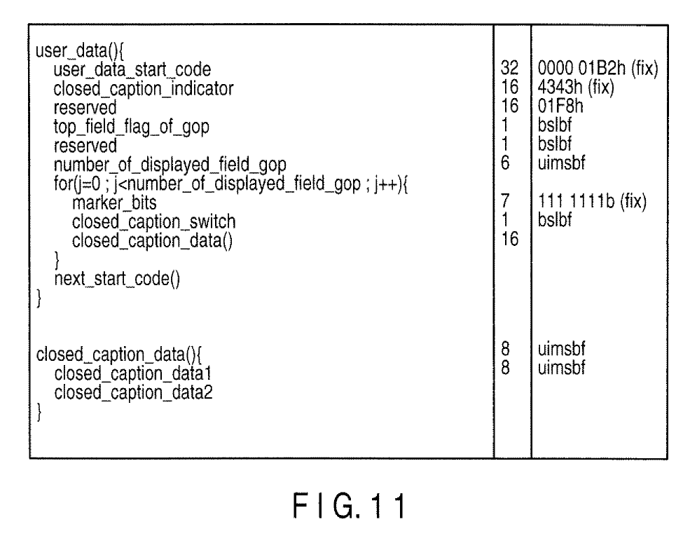

FIG. 9 is an example of the configuration of the video recording/reproducing device in which a map image is downloaded from a server providing a map Web service on the internet and synchronized with a video recorded by the video recording/reproducing device; and they are combined and displayed, as shown in FIG. 10. This example uses a video recorded by, for example, a video camera with GPS (Global Positioning System). The recorded video contains information about the latitude, longitude, and direction of the recorded place. The latitudes, longitudes, directions, etc. may be contained in, for example, the user data or closed caption in MPEG2. In this configuration example of the device, data is inserted in the MPEG2 video, specifically, in an area called “extension-and-user-data” located immediately after a group-of-pictures-header or a picture-header. However, a DVD standard has already defined the method for inserting a closed caption in the extension-and-user data immediately after a group-of-pictures-header. Therefore, this configuration example employs the method of inserting additional information, such as position information for use as a closed caption, according to this DVD standard. In the DVD standard, the information about a closed caption to be contained in line 21 as shown in FIG. 4 is inserted in the extension-and-user-data located immediately after a group-of-pictures-header. FIG. 11 shows the format for a closed caption inserted in the extension-and-user-data.

Information added for use as a closed caption is in text form. In this example, longitude and latitude each are described in the range of 0.0 to 360.0 degrees, with a unit of 0.1-degree, a four-digit decimal number, and character strings “LO” and “LA” for longitude and latitude, respectively. For example, a place at a 35-degree longitude and a 139-degree latitude is described as “LO0350LA1390.” Altitude is described in the range of −1000 to +8999m, with a unit of m, a four-digit decimal number obtained by adding 1000 to the actual value, and a character string “HI” given at the beginning of a description. For example, an altitude of 600 is described as “HI1600.” A direction is described in the range of a counterclockwise rotation of 360 degrees having the north as 0 degrees, with a three-digit decimal number, and a character string “OR” at the beginning of a description. For example, the north is described as “DR000.” If a place situated in the north at a longitude of 35 degrees, a latitude of 139 degrees, and an altitude of 400 m is described in a character string following the foregoing rule, text represented by “LO0350LA1390HI1400DR000” is given. Such a text is inserted per GOP (Group of Picture) for use as a closed caption.

In addition to the foregoing example of the configuration, the lower-level reproducing module incorporating the HTTP server has an MPEG2 decoder. The MPEG2 decoder has a function for extracting a closed caption from a COP header, decoding the closed caption, extracting inserted position information such as longitude, latitude, and direction, and transferring the position information to a host device along with the associated PTS (Presentation Time Stamp) provided for the frame. Additionally, this lower-level reproducing module has a function for providing the position information including the latitude, longitude, direction and associated PTS extracted from the GOP to a GUT application operating on a browser as a Web application, and a function for providing the current STC (System time clock). The GUI application is executed on a Web browser described as a Web application in HTML and JavaScript. In this configuration example, positional information and map information are acquired and combined by a module shown in FIG. 9 and described in JavaScript. A positional information reading thread receives extracted position information including a latitude, longitude, and direction along with PTS serving as timing information from a lower-level player module by means of HTTP. These pieces of information are transferred to a map image download module. Following the received information about the latitude and longitude, the map image download module receives, as an image, map information about a target area from the Web server on the Internet. Subsequently, the map image, direction information, and PTS, which are arranged in a set, are put into a queue. A picture update module compares the PTS of the set of data located at the beginning of the queue with STC read from a lower-level module in real time and waits for the display timing. When the time to display comes, the picture update module fetches the data from the queue, rotates the map image according to the direction, and inscribes the data on the picture. The image of the graphic output on the Web browser and the image of the output of the MPEG2 decoder are superimposed in hardware form so that one graphic comes on the top of the other. Thus, the superimposed images are output as the final video signal.

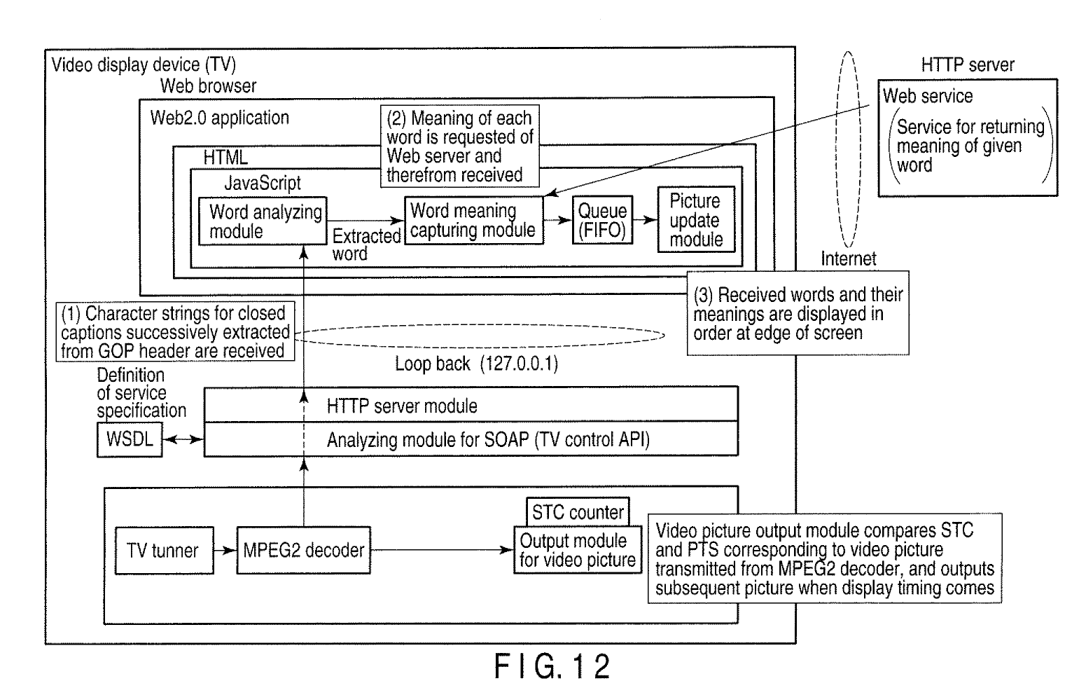

FIG. 12 is an example of the configuration of the video display device (i.e., television) that functions in such a manner that, using a control function implemented as a Web service, a Web application operating on a browser acquires the captionsr closed captions, electronic program guide (BPS) or other information of a TV broadcast currently being received. This video display device extracts a word from the character string of the displayed closed caption, obtains the meaning of the extracted word from a site providing a dictionary service as API (Application Program Interface) on the Internet in real time. In this video display device, the MPEG2 decoder receives the video data of the MPEG2 from a TV tuner and decodes this data. At this time, data about the closed caption inserted in the user data of the picture header is extracted. The extracted data is transmitted to the Web application by the HTTP server. GUI incorporated as a Web application is described in HTML and JavaScript. A JavaScript word analyzing module receives the closed caption data from a lower-level module by HTTP. The word analyzing module analyzes the data of the received closed caption, extracts a noun from the result, and transfers the noun to a word meaning interpretation module. The word meaning interpretation module investigates the meaning of the extracted word, referring to an HTTP server providing a dictionary service on the Internet, and receives data about the meaning of the target word.

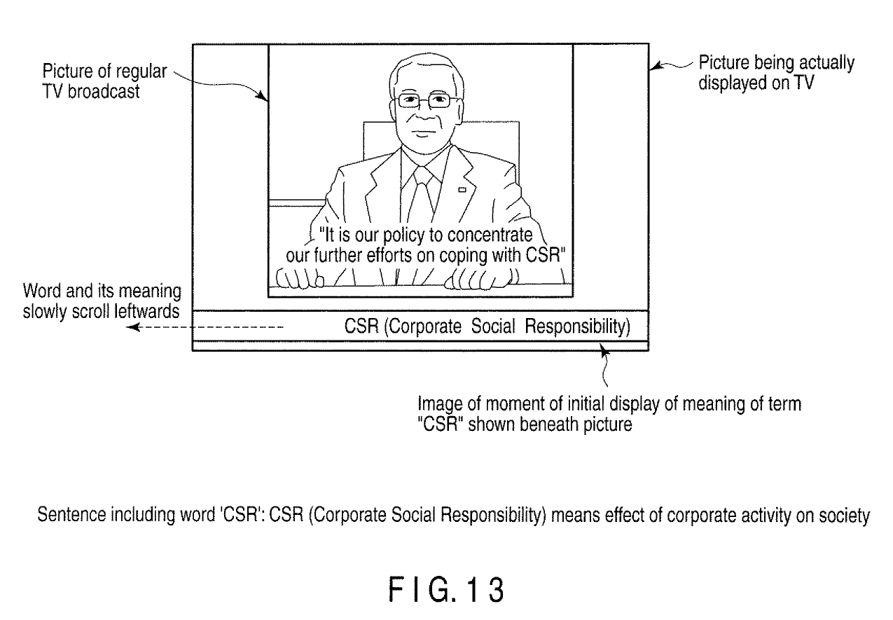

The word and document data about the meaning are registered in a queue. If there are any data about the word to be displayed in a queue, they are sequentially inscribed as captions in the lower-level part of a picture as shown in FIG. 13, and these are scrolled from right to left. This enables a user to check an unclear word while viewing the closed caption. The present embodiment has been described using a closed caption as an example. However, the embodiment is able to provide a similar function for a caption multiplexed to serve as a Sub-picture stream for DVD.

In the video processing device and its control method in the foregoing embodiment, a graphical user interface (GUI) module is acquired as a Web application; a user interface is provided by a Web browser that executes the Web application for the GUI module; and a sequence control related to a video processor and acquisition of status information are performed by a lower-level control module incorporating an HTTP (Hypertext Transfer Protocol) server which communicates with the user interface on the Web browser. That is, since the GUI module is in the form of a Web application, it is unnecessary to rewrite firmware in order to correct a defect in the user interface or in order to provide an additional function. Further, when the device is of a type with a ROM storing dedicated firmware, a user does not have to learn the manner of manual operations again, upon change in the model of the device.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video processing device comprising:
a video processor configured to process video information; and
a controller configured to control the video processor, the controller including:
a graphical user interface (GUI) module acquired in the form of a Web application;
a Web browser which provides a user interface upon execution of the Web application for the GUI module; and
a lower-level control module which incorporates an HTTP (Hypertext Transfer Protocol) server to perform a sequence control related to the video processor and acquisition of status information in communication with the user interface on the Web browser.

2. The video processing device of claim 1, wherein when the video processing device operates alone, communication between the GUI module and HTTP server of the lower-level control module is performed by a loop back function of an operating system provided in the controller.

3. The video processing device of claim 1, wherein the GUI module is a Web-service-type GUI that simultaneously displays on a single screen: a user interface for another video processing device connected via a network; a user interface for the controller; and a homepage for another HTTP server on an Internet.

4. The video processing device of claim 3, wherein the controller includes a function of using a Web service asynchronously controllable by a script, providing PTS (Presentation Time Stamp) for a frame currently displayed, current time, STC (System Time Clock), and video content being reproduced, to the Web application in real time, and displaying information about the reproduction in synchronization with the video reproduction by the Web application.

5. The video processing device of claim 2, wherein the controller includes a function of using a control function implemented as a Web service, and controlling the Web application operating on the Web browser to acquire information added to an image for a subtitle or closed caption provided for a TV broadcast currently being received by an HTTP protocol.

6. The video processing device of claim 1, wherein the controller includes a function of using a control function implemented as a Web service, and providing user data inserted in a picture header of an encoded video being reproduced and information contained in a video stream, to the Web application in synchronization with associated PTS (Presentation Times Stamp) and STC (System Time Clock).

7. The video processing device of claim 1, wherein the controller includes:
a function of using a control function implemented as a Web service, and providing user data inserted in a picture header of an encoded video being reproduced and information contained in a video stream, to the Web application in synchronization with associated PTS (Presentation Time Stamp) and STC (System Time Clock); and
a function of providing STC (System Time Clock) for use in timing synchronization to the Web application by an HTTP protocol.

8. A control method for a video processing device having a video processor configured to process video information and a controller configured to control the video processor, the method comprising:
acquiring a graphical user interface (GUI) module in the form of a Web application;
providing a user interface by a Web browser which executes the Web application for the GUI module; and
performing a sequence control related to the video processor and acquisition of status information by a lower-level control module incorporating an HTTP (Hypertext Transfer Protocol) server which communicates with the user interface on the Web browser.

9. The control method of claim 8, wherein when the video processing device operates alone, communication between the GUT module and HTTP server of the lower-level control module is performed by a loop back function of an operating system provided in the controller.

10. The control method of claim 8, wherein the GUI module is a Web-service-type GUI that simultaneously displays on a single screen: a user interface for another video processing device connected via a network; a user interface for the controller; and a homepage for another HTTP server on an Internet.
